(19) United States
(12) Patent Application Publication
(10) Pub. No.: US 2008/0195436 A1
(43) Pub. Date: Aug. 14, 2008

(54) Automated supplier self audit questionnaire system

(76) Inventor: Stephen Joseph Whyte, Leicester (GB)

Correspondence Address: PIETRAGALLO GORDON ALFANO BOSICK & RASPANTI LLP, ONE OXFORD CENTRE, 38TH FLOOR, 301 GRANT STREET, PITTSBURGH, PA, 15219-6404, US

(21) Appl. No.: 12/004,577

(22) Filed: Dec. 21, 2007

Related U.S. Application Data
(60) Provisional application No. 60/876,320, filed on Dec. 21, 2006.

(51) Int. Cl. G06Q 30/00

(52) U.S. Cl. 705/7

(57) ABSTRACT

The present system comprises a number of discrete elements, which when combined provide a solution which has not been attainable in the industry. A database of answer templates provides the answers to all conceivable questions asked on supplier self audit questionnaires. A web portal allows manufacturers access to the above template to allow personalisation of the answers to their own business. A routine to map each questionnaire into this database is provided. In one embodiment, technologists at a central location may perform the mapping of questionnaires. However, customers may directly map their own questionnaires, if desired. A software suite may be provided which manages access, security and general portal administration.

### CROSS-REFERENCE TO RELATED APPLICATION

This application claims the benefit of U.S. Provisional Application No. 60/876,320 filed Dec. 21, 2006, which is incorporated herein by reference.

### FIELD OF THE INVENTION

The present invention relates to supplier self audit questionnaires, and more particularly relates to an automated system for supplier self audit questionnaires.

### BACKGROUND INFORMATION

The manufacture of foodstuffs is a highly regulated industry. As a result, food manufacturers need to complete extensive due diligence of their supply chains. A regular tool used within this due diligence is supplier self audit questionnaires.

Each manufacturer usually has their own format of questionnaire with specific questions and layouts which are usually presented on an MS Word document. Current practice entails manufacturers emailing these questionnaires to their suppliers who then either print them for completion by hand, or type into the Word document received.

Conventional supplier self audit questionnaires are completed by the supplier and returned to their customer. The customer reviews and evaluates these questionnaires. There is no standardization and each questionnaire is therefore seen as a unique questionnaire which needs completion. Questionnaires vary in the following ways: physical layout and design; format of questions, open or closed or a mixture; actual questions asked; space provided for answers; and requirements to attach supplementary documentation.

Because the manufacturing and supply of foodstuffs is highly fragmented, it has not been possible to standardize requirements. This is also due to each manufacturer taking a different view on what due diligence information needs to be gathered from their supply chain. Therefore it has not been possible to automate the process of questionnaire completion. These questionnaires are therefore labor intensive.

The present invention has been developed in view of the foregoing.

### SUMMARY OF THE INVENTION

An aspect of the present invention is to provide a method of providing questionnaire answers from suppliers to manufacturers comprising: inputting a relatively large number of manufacturer questions supplied by a plurality of manufacturers to a database; establishing a master questionnaire comprising a relatively small number of selected questions derived from the manufacturer questions; allowing suppliers to access the master questionnaire and to answer the selected questions; associating the answers provided by at least one of the suppliers with the manufacturer questions supplied by at least one of the manufacturers; and transmitting to said at least one manufacturer answers to the manufacturer questions supplied by said at least one manufacturer based upon the answers provided by said at least one supplier to the selected questions of the master questionnaire. As used herein, the terms “relatively large” and “relatively small”, when referring to the number of manufacturer questions and the number of selected questions derived therefrom, mean that there are at least 50 percent less selected questions than manufacturer questions, typically at least 75 percent less. In certain embodiments, the selected questions contained in the master questionnaire are at least 85 percent less than the number of manufacturer questions, or even 90 or 95 percent less. As a particular example, there may be over 10,000 different manufacturer questions, but the selected questions contained in the master questionnaire may be less than 1,500 or 1,000, or even less than 500.

Another aspect of the present invention is to provide an automated supplier self questionnaire system comprising: a database comprising a relatively large number of manufacturer questions from a plurality of manufacturers; a master questionnaire comprising a relatively small number of selected questions derived from the manufacturer questions; means for allowing suppliers to access the master questionnaire and to answer the selected questions; means for associating the answers to the selected questions of the master questionnaire provided by at least one of the suppliers with the manufacturer questions supplied by at least one of the manufacturers; and means for transmitting to said at least one manufacturer answers to the manufacturer questions supplied by said at least one manufacturer based upon the answers provided by said at least one supplier to the selected questions of the master questionnaire.

A further aspect of the present invention is to provide a method of providing questionnaire answers to a manufacturer comprising: the manufacturer providing questions to an automated supplier self questionnaire system; and the manufacturer receiving from the automated supplier self questionnaire system answers to the questions provided by the manufacturer. The automated supplier self questionnaire system comprises: a database comprising a relatively large number of manufacturer questions from a plurality of manufacturers; a master questionnaire comprising a relatively small number of selected questions derived from the manufacturer questions; means for allowing suppliers to access the master questionnaire and to answer the selected question; means for associating the answers to the selected questions of the master questionnaire provided by at least one of the suppliers with the manufacturer questions supplied by at least one of the manufacturers; and means for transmitting to said at least one manufacturer answers to the manufacturer questions supplied by said at least one manufacturer based upon the answers provided by said at least one supplier to the selected questions of the master questionnaire.

Another aspect of the present invention is to provide a method providing questionnaire answers from a supplier comprising: the supplier providing answers to questions from an automated supplier self questionnaire systems, wherein the automated supplier self questionnaire system comprises a database comprising a relatively large number of manufacturer questions from a plurality of manufacturers; a master questionnaire comprising a relatively small number of selected questions derived from the manufacturer questions; means for allowing suppliers to access the master questionnaire and to answer the selected questions; means for associating the answers to the selected questions of the master questionnaire provided by at least one of the suppliers with the manufacturer questions supplied by at least one of the manufacturers; and means for transmitting to said at least one manufacturer answers to the manufacturer questions supplied by said at least one manufacturer based upon the answers provided by said at least one supplier to the selected questions of the master questionnaire.

These and other aspects of the present invention will be more apparent from the following description.

### BRIEF DESCRIPTION OF THE DRAWINGS

FIG. 1 illustrates a conventional process for the completion of multiple supplier self audit questionnaires for multiple customers.

FIG. 2 illustrates an automated supplier self audit questionnaire system in accordance with an embodiment of the present invention.

FIG. 3 illustrates a network design for use in accordance with an embodiment of the present invention.

FIG. 4 is a schematic flow diagram illustrating operation of an automated supplier self audit questionnaire system in accordance with an embodiment of the present invention.

FIGS. 5a-d illustrate extracts from the hygiene section of blank questionnaires, from four different manufacturers (numbered manufacturer 1 through 4). These are currently being sent to suppliers for manual completion.

FIG. 6 is an extract from the database showing the hygiene section from the list of “master” questions and showing the answers to these master questions that three suppliers (numbers 1 to 3) have uploaded to the system.

FIG. 7 shows how the questions from each of the blank questionnaires in FIGS. 5a-d have been mapped by technologists to the database and that the answers provided by the suppliers as shown in FIG. 6 (supplier 1 used as an example) are pulled through to answer the mapped question.

FIGS. 8a-d show what the questionnaires from FIGS. 5a-d look like when completed with the answers provided by Supplier 1 based on the mapping outlined in FIG. 7.

### DETAILED DESCRIPTION

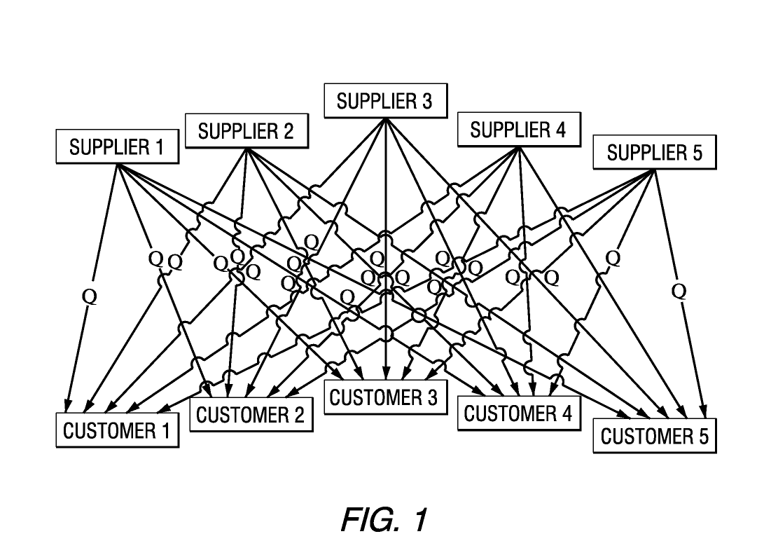

FIG. 1 illustrates a conventional process for the completion of multiple supplier self audit questionnaires for multiple customers. As shown in FIG. 1, each customer or manufacturer has a personalized questionnaire. Each of the different types of questionnaires are completed manually by the suppliers. Such a process involves a large amount of duplication between questionnaires, and is time consuming for suppliers and customers or manufacturers.

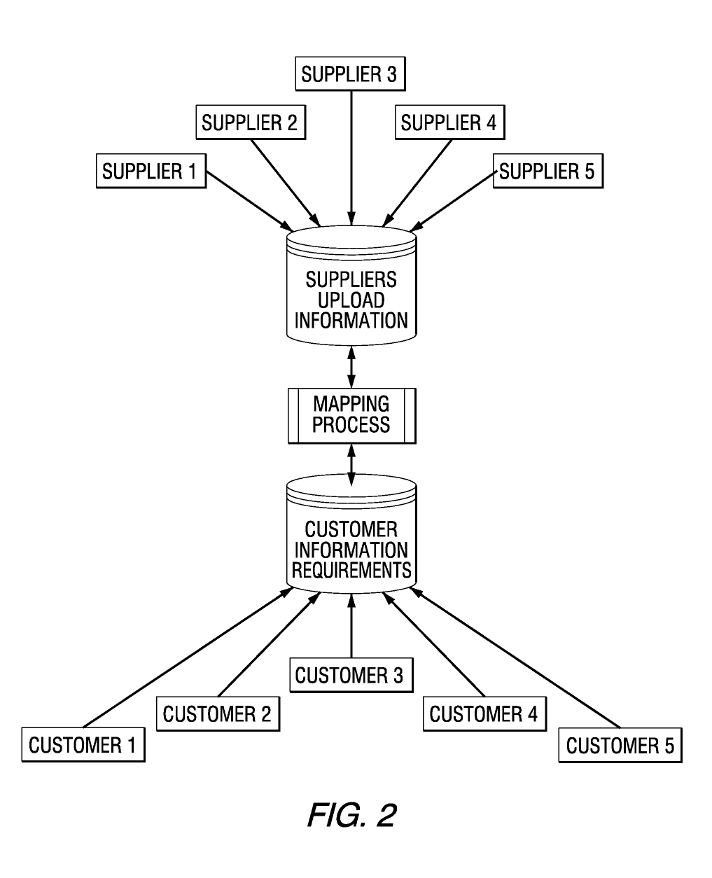

FIG. 2 illustrates an automated supplier self audit questionnaire system in accordance with an embodiment of the present invention. As shown in FIG. 2, each customer or manufacturer still has a personalized questionnaire. However, the suppliers upload one set of data to the database, and a mapping process matches requirements. A completed questionnaire is generated without manual input by suppliers or customers.

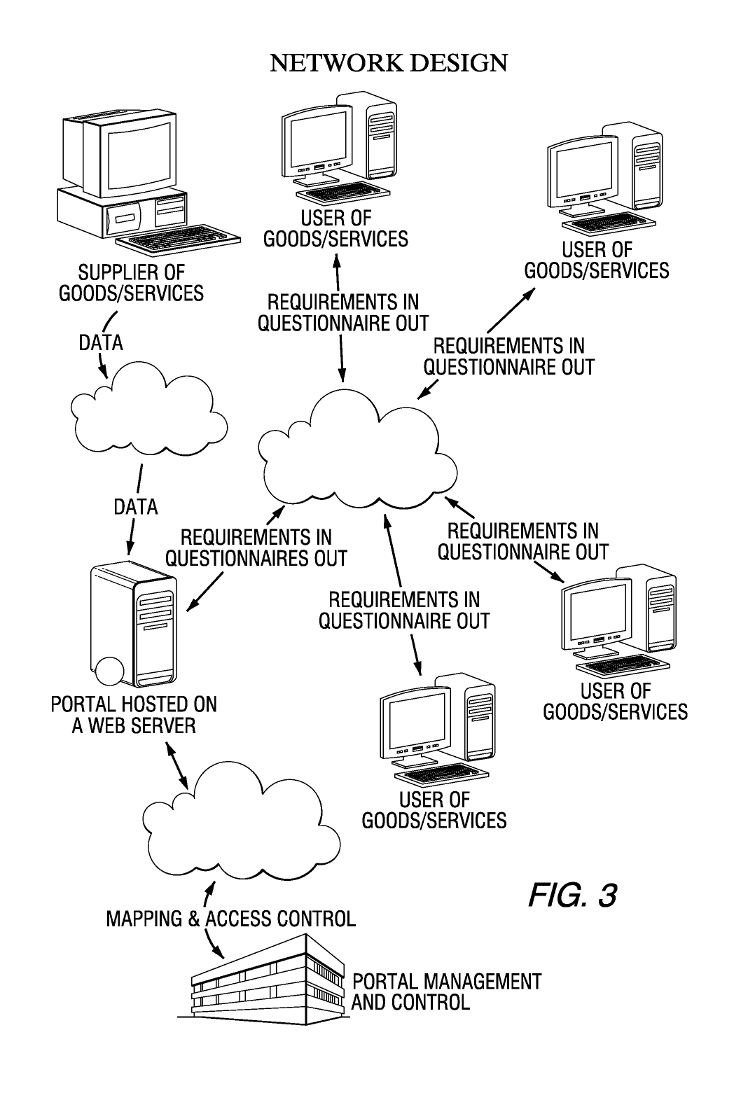

FIG. 3 illustrates a network design for use in accordance with an embodiment of the present invention. The network illustrated in FIG. 3 illustrates how suppliers of goods and services upload their data once. Multiple users can draw on that data in whatever format they wish. The process is controlled by portal management and control.

In accordance with the present invention, it has been recognized that there are a finite number of possible answers to all the different questions appearing on supplier self audit questionnaires, and that this finite list is substantially shorter than one would expect. Therefore, regardless of the format of a questionnaire or the method of presenting the questions, the process can be automated as follows: (1) a database containing templates which need populating with the relevant answers from each supplier wishing to use the solution is set up; (2) secure access rights to supplier to access and update their information on this database using a web interface is granted; (3) the supplier receives a request to complete a questionnaire from a customer; (4) a routine configuring the questionnaire to the database template is completed; (5) the questionnaire is loaded into the system with all existing layouts intact; and (6) the supplier sets their customer up as an approved trading partner on the portal. The supplier can then run a routine that populates the questionnaire and emails or otherwise transmits it with all relevant attachments to their customer.

Many suppliers may typically complete an average of five questionnaires per week. The time taken to populate the entire database of the present invention by a supplier should be similar to that required to complete five questionnaires. Thereafter, the present system is able to complete all questionnaires without manual intervention from the supplier.

Benefits which accrue to users of the present invention include the ability to inform all customers automatically of any changes to any answer that is of interest to a particular customer, the ability for trading partners to respond to emerging food safety threats without the need to resubmit entire questionnaires, and the ability for customer definition of desirable and undesirable answers to closed questions. The system can then generate exception reports for customers identifying answers to questions that are not desirable. This saves customers analysis time. Additional benefits include the ability to prompt all parties to update any information or documents that have expiry dates, such as licenses etc., and improved accuracy and speed of completion of questionnaires. Furthermore, the present methodology can be applied to other industries with similar challenges.

The present system comprises a number of discrete elements, which when combined provide a solution which has not been attainable in the industry. A database of answer templates provides the answers to all conceivable questions asked on supplier self audit questionnaires. A web portal allows manufacturers access to the above template to allow personalisation of the answers to their own business. A routine to map each questionnaire into this database is provided. In one embodiment, technologists at a central location may perform the mapping of questionnaires. However, customers may directly map their own questionnaires, if desired. A software suite may be provided which manages access, security and general portal administration.

Although the use of this present system in the food industry is primarily described herein, the system may be used in other applications such as medical products, pharmaceutical, chemicals, solvents, and the like.

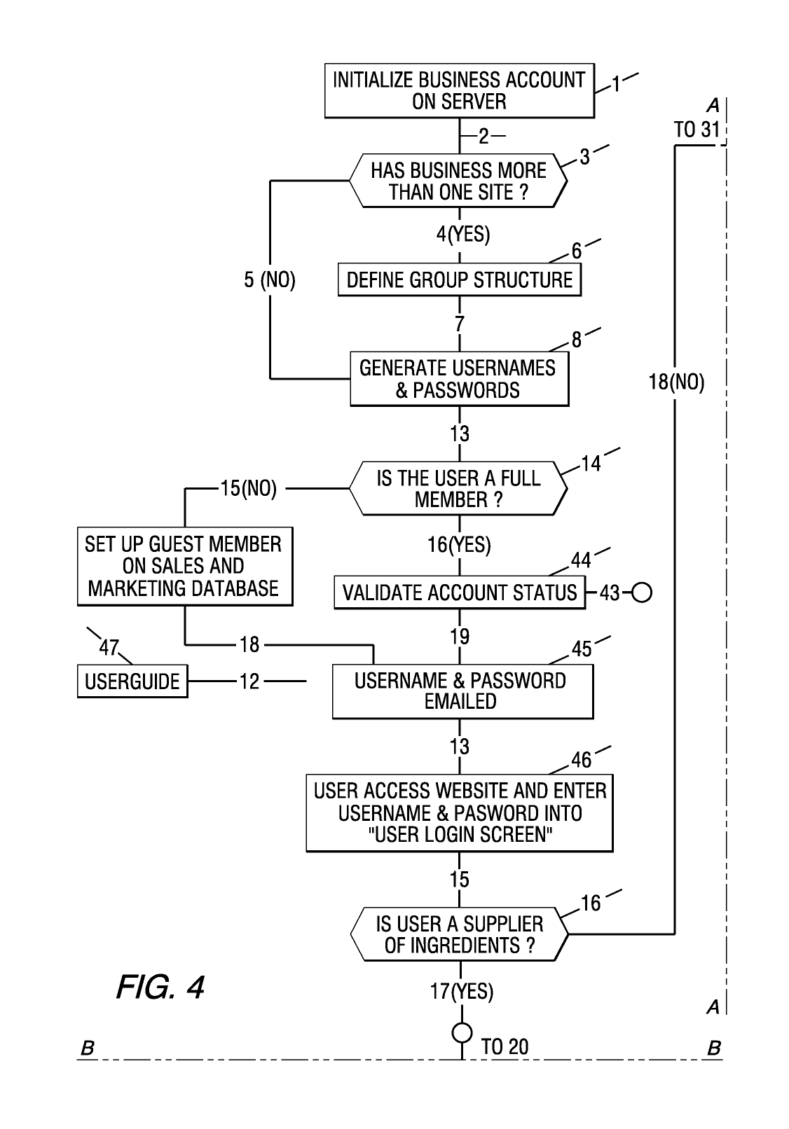

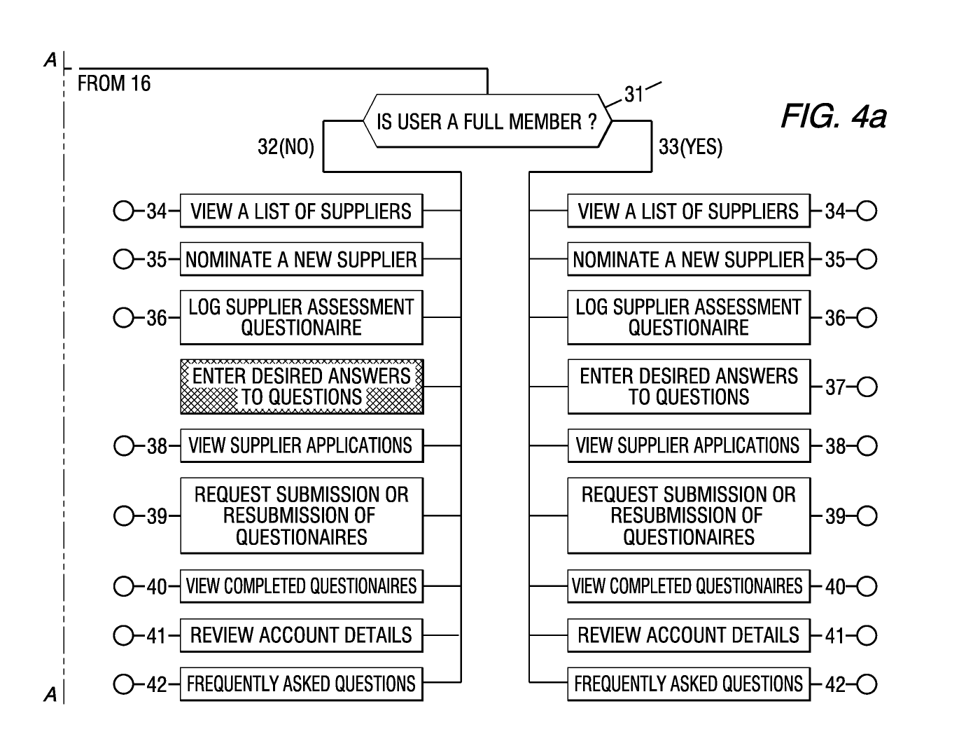

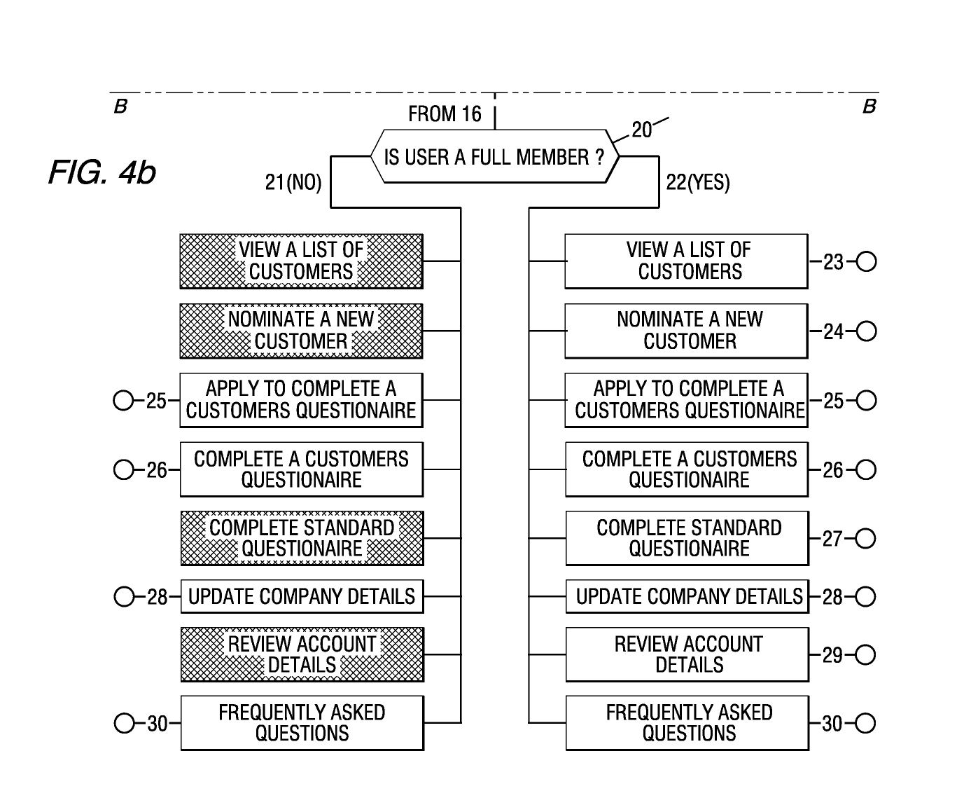

FIG. 4 is a schematic flow diagram illustrating operation of an automated supplier self audit questionnaire system in accordance with an embodiment of the present invention. The first step shown in FIG. 4 is to initialize a business account on a server. If the business has more than one site, a group structure is defined and user names and passwords are generated. If the business has only one site, user names and passwords are generated without the necessity of defining a group structure. If the user is a full time member, the user's account status is validated. If the user is not a full time member, the user is set up as a guest member on a sales and marketing database. Once the user name and password have been established, the user accesses a website and enters its user name and password into a user logon screen. If the user is a supplier of ingredients, and is a full member, the user can select from several options including viewing a list of customers, nominating a new customer, applying to complete a customer questionnaire, completing a customer questionnaire, completing a standard questionnaire, updating company details, reviewing account details and selecting frequently asked questions. If the user is not a full member, the user's options are limited to applying to complete a customer questionnaire, completing a customer questionnaire, updating company details and selecting frequently asked questions. If the user is not a supplier of ingredients and is a full time member, the user may select from several options including viewing a list of suppliers, nominating a new supplier, logging a supplier assessment questionnaire, entering desired answers to questions, viewing supplier applications, requesting submission or re-submission of questionnaires, viewing completed questionnaires, reviewing account details and selecting frequently asked questions. If the user is not a full member, all of the foregoing selections are available except entering desired answers to questions.

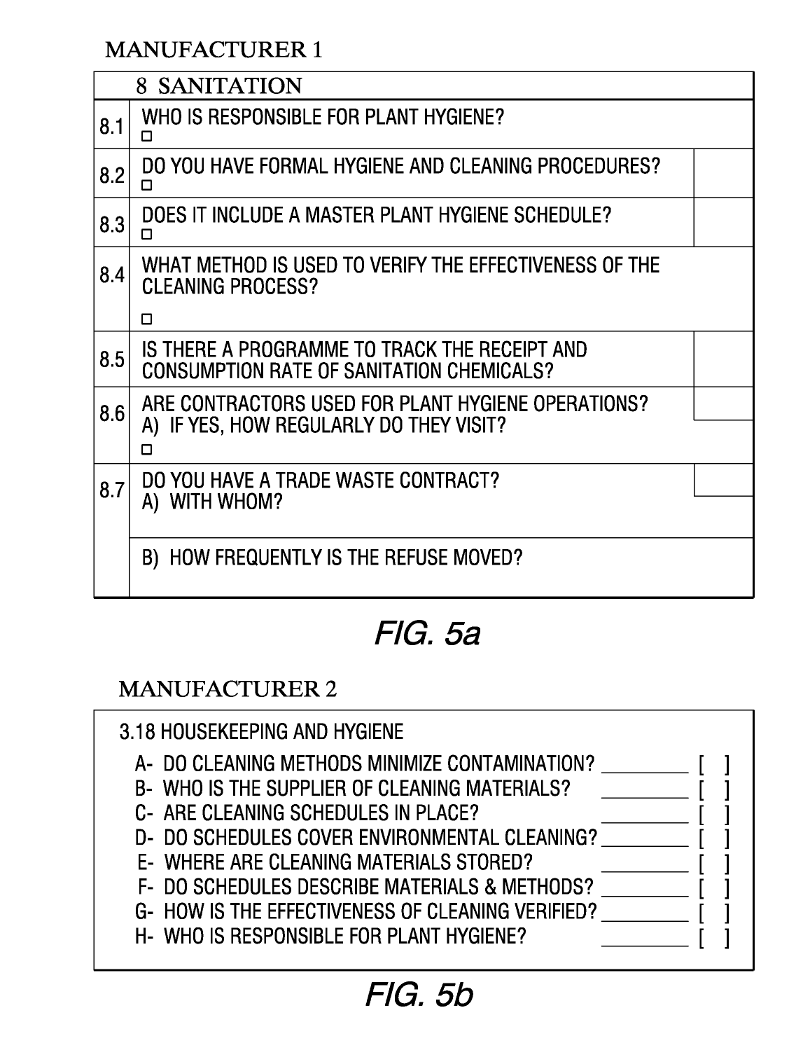

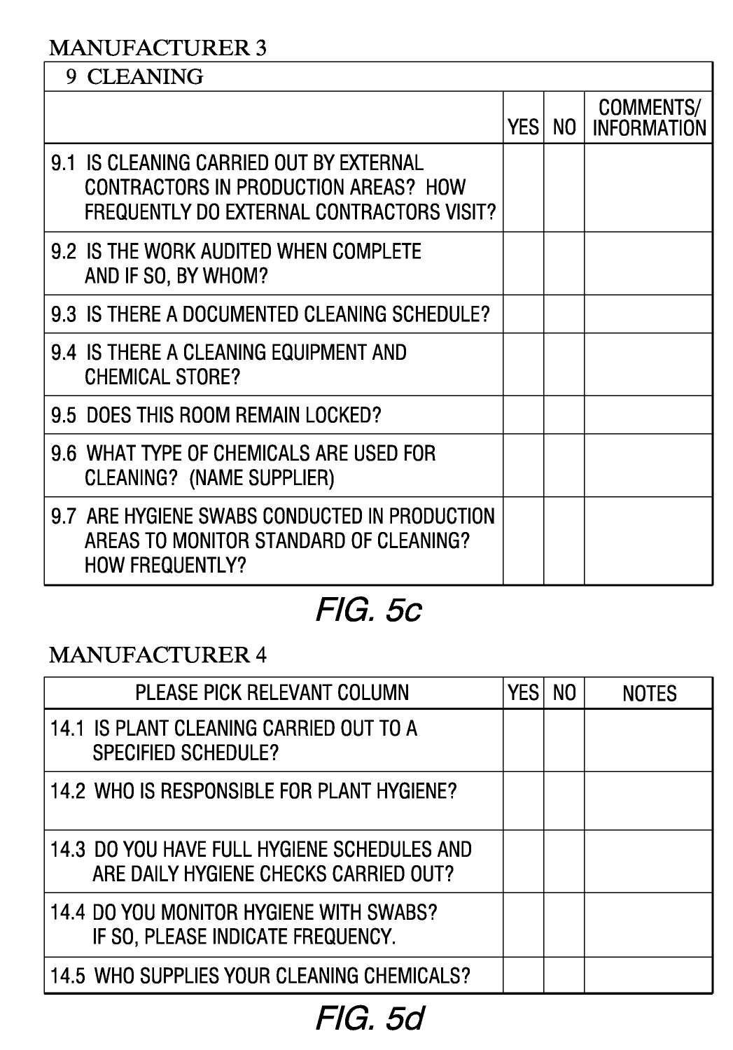

FIGS. 5a-d illustrate extracts from the hygiene section of blank questionnaires, from four different manufacturers (numbered manufacturer 1 through 4). These are representative of questions which are currently being sent to suppliers for manual completion.

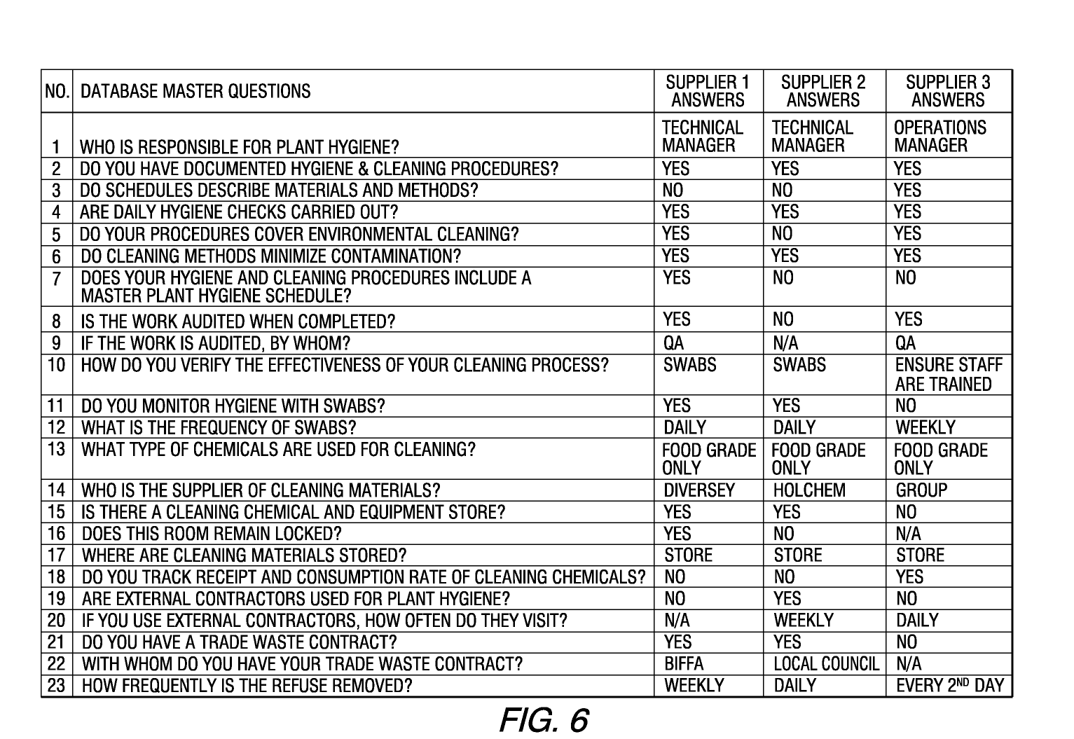

FIG. 6 is an extract from the database showing the hygiene section from the list of master questions and showing the answers to these master questions that three suppliers (numbers 1 to 3) have uploaded to the system.

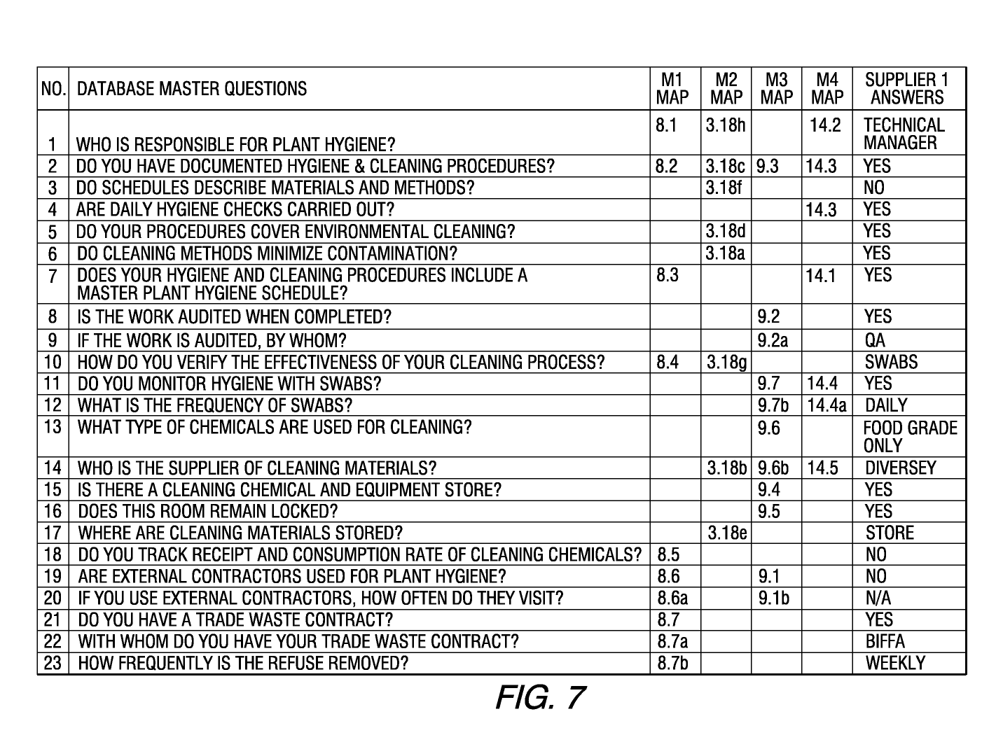

FIG. 7 shows how the questions from each of the blank questionnaires in FIGS. 5a-d have been mapped by technologists to the database and that the answers provided by the suppliers as shown in FIG. 6 (supplier 1 used as an example) are pulled through to answer the mapped question.

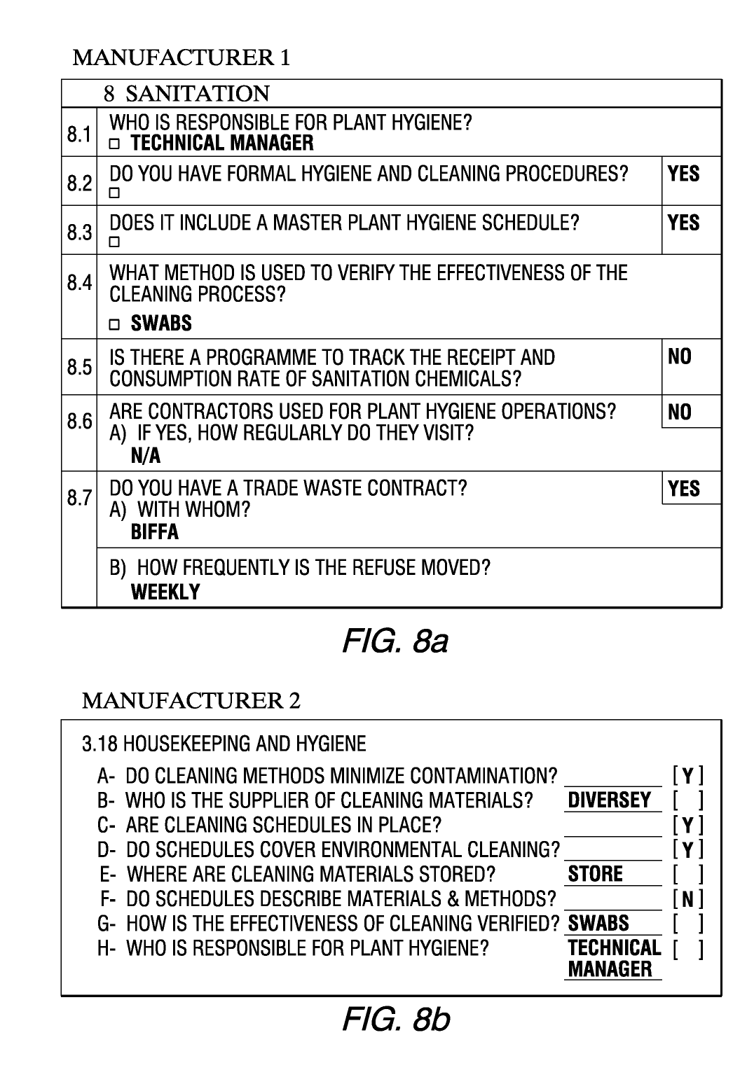

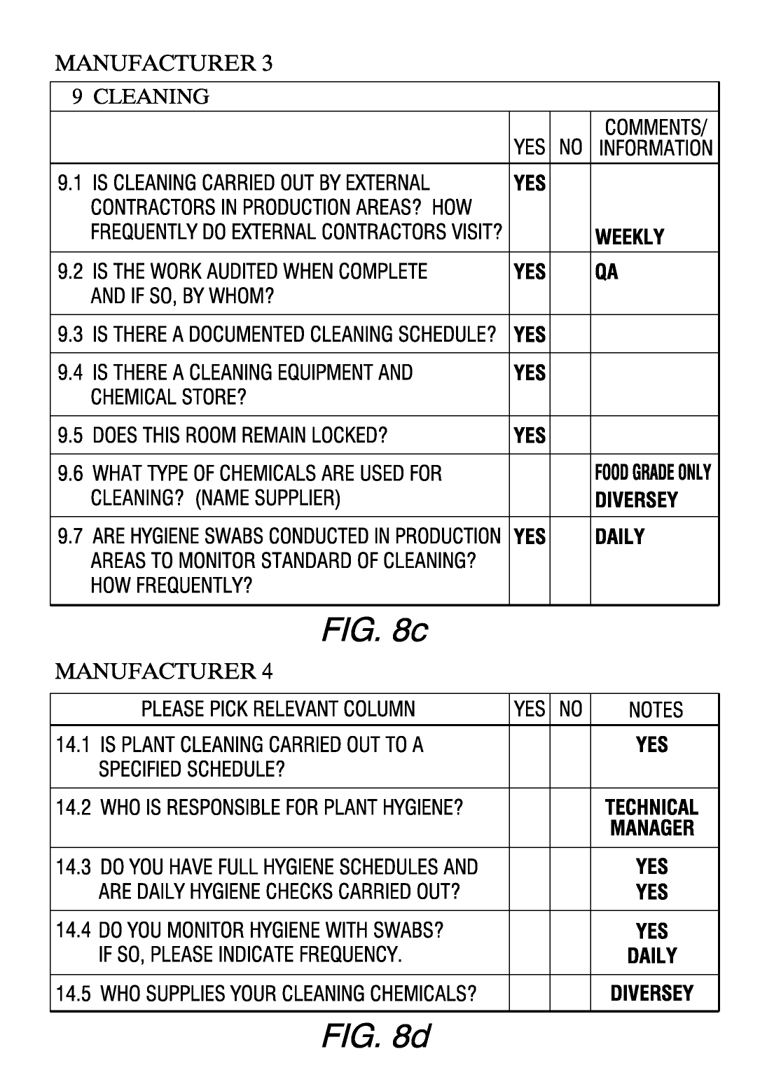

FIGS. 8a-d show what the questionnaires from FIGS. 5a-d look like when completed with the answers provided by Supplier 1 based on the mapping outlined in FIG. 7.

In accordance with an embodiment of the present invention, at least some of the questions used on the master questionnaire are derived from multiple manufacturer questions, such that an answer to a single master questionnaire question provides answers to several different manufacturer questions. An example is shown in Table 1, where a supplier's answer to the single question in the left column allows seventeen different manufacturer questions shown in the right column to be answered.

TABLE 1

| | | | |
|---|---|---|---|
| 1 | 42.1.49 List what allergenic | 1 | 42.1.29 Does your site handle any serious allergens on site? |
| | materials you have on site | 2 | 42.1.07 Does the site handle seeds |
| | | 3 | 42.1.33 Does the Factory manufacture or process Shellfish |
| | | | (Allergen)? |
| | | 4 | 42.1.34 Does the Factory manufacture or process fish |
| | | | (Allergen)? |
| | | 5 | 42.1.35 Does the Factory manufacture or process Eggs |
| | | | (Allergen)? |
| | | 6 | 42.1.36 Does the Factory manufacture or process Sulphur |
| | | | dioxide (Allergen)? |
| | | 7 | 42.1.37 Does the Factory manufacture or process Wheat |
| | | | (Allergen)? |
| | | 8 | 42.1.38 Does the Factory manufacture or process Mustard |
| | | | (Allergen)? |
| | | 9 | 42.1.39 Does the Factory manufacture or process Celery & |
| | | | Celeriac (Allergen)? |
| | | 10 | 42.1.40 Does the Factory manufacture or process Seeds and |
| | | | Nuts (Allergen)? |
| | | 11 | 42.1.41 Does the Factory manufacture or process Gluten |
| | | | (Allergen)? |
| | | 12 | 42.1.42 Does the Factory manufacture or process Soya |
| | | | (Allergen)? |
| | | 13 | 42.1.44 Does the factory manufacture or process milk |
| | | | products? |
| | | 14 | 42.1.45 Does the factory manufacture or process Kiwi fruit? |
| | | 15 | 42.1.47 Does the Factory manufacture or process Dairy |
| | | | products (Allergen)? |
| | | 16 | 42.1.48 Does the Factory manufacture or process Lupins |
| | | | (Allergen)? |
| | | 17 | 42.1.20 Is the site nut free. |

Furthermore, different types of industry standards may be used in accordance with the present invention to derive a relatively small number of questions on the master questionnaire from a relatively large number of different manufacturer questions. An example of such an industry standard is the British Retail Consortium (BRC) Food Technical Standards. The BRC Food Technical Standards are used to evaluate food products in order to help retailers and brand owners with their due diligence requirements. This standard is regarded as the benchmark for best practices in the food industry, and its use has evolved into a Global Standard used not just to assess retailer suppliers, but as a framework upon which many companies have based their supplier assessment programs. Following the success and widespread acceptance of the Global Standard for food, the BRC published the Packaging Standard, the Consumer Products Standard, and the BRC Global Standard for storage and distribution. In accordance with an embodiment of the present invention, the master questionnaire may include a question such as: Is your site BRC accredited? A “yes” answer to this question by a supplier provides answers to many different manufacturer questions.

Another standard from which master questionnaire questions may be established is the Hazard Analysis Critical Control Points (HACCP) standard, which is a food safety methodology that relies on the identification of Critical Control Points (CCP's) in food production and preparation processes. The CCPs are closely monitored in order to ensure that food is safe for consumption. Table 2 lists several different manufacturer questions relating to HACCP standards. The master questionnaire may include a question such as: Is your site HACCP accredited? A “yes” answer to this question by a supplier provides answers to all of the different questions listed in Table 2.

```
TABLE 2
1 Hazard Analysis
    1 HACCP Development
        1 HACCP Development
            11.1.03 If HACCP is in place, do you have a HACCP team?
            11.1.05 Is the following stage used in your HACCP? - Conduct a hazard
analysis
            11.1.06 Is the following stage used in your HACCP? - Determine the CCP's
            11.1.07 Is the following stage used in your HACCP? - Establish critical limits
            11.1.08 Is the following stage used in your HACCP? - Establish systems to
            monitor control of CCP's
            11.1.09 Is the following stage used in your HACCP? - Establish corrective
            actions to be taken
            11.1.10 Is the following stage used in your HACCP? - Establish verification
            procedures
            11.1.11 Is the following stage used in your HACCP? - Establish appropriate
            documentation
            11.1.12 Is the following stage used in your HACCP? - Follow relevant codes of
            practice
        2 HACCP Team
            11.2.01 Does the HACCP team have appropriate experience
            11.2.02 Are key personnel in HACCP team trained
            11.2.03 Are all new & revised products & processes covered
            11.2.04 Are records kept of conformance and corrective action
            11.2.05 Is HACCP work carried out by a multi-disciplinary team
            11.2.09 If HACCP is not in place, When will it be implemented
            11.2.10 If HACCP is not in place, describe what product safety systems are
            currently in place
            11.2.14 Do you have adequate resources to effectively operate HACCP?
    2 HACCP Procedures
        1 HACCP Procedures
            12.1.02 Are all HACCP records legible and genuine
```

Thus, a relatively small number of questions may be provided in the master questionnaire which are derived from a significantly larger number of different questions from multiple manufacturers.

Whereas particular embodiments of this invention have been described above for purposes of illustration, it will be evident to those skilled in the art that numerous variations of the details of the present invention may be made without departing from the invention as defined in the appended claims.

1. A method of providing questionnaire answers from suppliers to manufacturers comprising:
inputting a relatively large number of manufacturer questions supplied by a plurality of manufacturers to a database;
establishing a master questionnaire comprising a relatively small number of selected questions derived from the manufacturer questions;
allowing suppliers to access the master questionnaire and to answer the selected questions;
associating the answers provided by at least one of the suppliers with the manufacturer questions supplied by at least one of the manufacturers; and
transmitting to said at least one manufacturer answers to the manufacturer questions supplied by said at least one manufacturer based upon the answers provided by said at least one supplier to the selected questions of the master questionnaire.

2. The method of claim 1, wherein said at least one manufacturer and said at least supplier are members of the food industry.

3. The method of claim 1, wherein the relatively small number of selected questions of the master questionnaire is at least 75 percent less than the relatively large number of manufacturer questions.

4. The method of claim 1, wherein the relatively small number of selected questions of the master questionnaire is at least 90 percent less than the relatively large number of manufacturer questions.

5. The method of claim 1, wherein there are at least 10,000 manufacturer questions and less than 1,000 selected questions derived from the manufacturer questions.

6. The method of claim 1, wherein the selected questions are derived from the manufacturer questions by a mapping process.

7. The method of claim 1, further comprising using at least one industry standard to derive at least some of the selected questions of the master questionnaire from the manufacturer questions.

8. An automated supplier self audit questionnaire system comprising:
a database comprising a relatively large number of manufacturer questions from a plurality of manufacturers;
a master questionnaire comprising a relatively small number of selected questions derived from the manufacturer questions;
means for allowing suppliers to access the master questionnaire and to answer the selected questions;
means for associating the answers to the selected questions of the master questionnaire provided by at least one of the suppliers with the manufacturer questions supplied by at least one of the manufacturers; and
means for transmitting to said at least one manufacturer answers to the manufacturer questions supplied by said at least one manufacturer based upon the answers provided by said at least one supplier to the selected questions of the master questionnaire.

9. A method of providing questionnaire answers to a manufacturer comprising:
the manufacturer providing questions to an automated supplier self questionnaire system; and
the manufacturer receiving from the automated supplier self questionnaire system answers to the questions provided by the manufacturer, wherein the automated supplier self questionnaire system comprises:
a database comprising a relatively large number of manufacturer questions from a plurality of manufacturers;
a master questionnaire comprising a relatively small number of selected questions derived from the manufacturer questions;
means for allowing suppliers to access the master questionnaire and to answer the selected question;
means for associating the answers to the selected questions of the master questionnaire provided by at least one of the suppliers with the manufacturer questions supplied by at least one of the manufacturers; and
means for transmitting to said at least one manufacturer answers to the manufacturer questions supplied by said at least one manufacturer based upon the answers provided by said at least one supplier to the selected questions of the master questionnaire.

10. A method providing questionnaire answers from a supplier comprising:
the supplier providing answers to questions from an automated supplier self questionnaire systems, wherein the automated supplier self questionnaire system comprises:
a database comprising a relatively large number of manufacturer questions from a plurality of manufacturers;
a master questionnaire comprising a relatively small number of selected questions derived from the manufacturer questions;
means for allowing suppliers to access the master questionnaire and to answer the selected questions;
means for associating the answers to the selected questions of the master questionnaire provided by at least one of the suppliers with the manufacturer questions supplied by at least one of the manufacturers; and
means for transmitting to said at least one manufacturer answers to the manufacturer questions supplied by said at least one manufacturer based upon the answers provided by said at least one supplier to the selected questions of the master questionnaire.
